(19) United States
(12) Patent Application Publication
(10) Pub. No.: US 2004/0222031 A1
(43) Pub. Date: Nov. 11, 2004

(54) Independent rear suspension and support assembly

(76) Inventors: Norman Szalony, Brighton, MI (US); Scott K. Hanba, Redford, MI (US); Craig V. Sutton, South Lyon, MI (US); Russell J. Knight III, Dearborn, MI (US); Gary Leevy, Farmington Hills, MI (US)

Correspondence Address: Dickinson Wright PLLC, Suite 800, 1901 L. Street NW, Washington, DC, 20036, US

(21) Appl. No.: 10/454,444

(22) Filed: Jun. 4, 2003

Related U.S. Application Data
(63) Continuation-in-part of application No. 10/435,585, filed on May 9, 2003.

(51) Int. Cl. B62D 21/00

(52) U.S. Cl. 180/311

(57) ABSTRACT

The independent suspension includes a suspension system and a support assembly. The support assembly generally includes a central member having a first end and a second end to which first and second end members are coupled. The support assembly generally spans between vehicle rails with the central member acting as a structural bridge between the end members. The central member defines a cavity and an input passage communicating with the cavity. A driveshaft may be coupled to an input member retained within the input passage which in turn is operably coupled to a torque transferring device disposed within the cavity. The torque transferring device transfers torque from the input member to a pair of output shafts. The end members are also coupled to a suspension system so that the end members may receive suspension load from the suspension system and transfer the suspension load to the other end member through the central member. The central member is designed to withstand both suspension load and driveline load.

### CROSS-REFERENCE TO RELATED APPLICATION

This application is a continuation-in-part of U.S. patent application Ser. No. 10/435,585, filed May 9, 2003, the entire disclosure of the application is considered part of the disclosure of this application and is hereby incorporated by reference.

### FIELD OF INVENTION

The invention relates to an independent rear suspension for a motor vehicle, wherein the vehicle includes a vehicle chassis or frame having a pair of spaced, generally-longitudinally-extending frame rails.

### BACKGROUND OF THE INVENTION

The prior art teaches an independent rear suspension for a motor vehicle in which a continuous, typically cast or stamped crossmember of a subframe assembly is bolted at each end to a respective frame rail through a first set of isolation mounts. One or more control arms, pivotally mounted on a respective portion of the crossmember, support a respective rear wheelend assembly relative to the vehicle chassis, whereby the wheelend assembly is positioned at a respective wheel location on the vehicle.

When such a typical rear subframe assembly is adapted to accept an electric drive, as when the vehicle is to incorporate a hybrid powerplant, the electric drive is typically bolted onto a center portion of the subframe assembly, such as the center portion of the assembly's continuous crossmember, through a dedicated set of isolation mounts. Such a configuration significantly increases the weight of the resulting subframe assembly, while further typically providing the subframe assembly with an increased vertical dimension that, in turn, triggers additional “packaging” design constraints.

Accordingly, what is needed is an independent rear suspension support assembly that is readily adapted to house an electric motor with which to drive a rear wheelend assembly that features a reduced assembly height and weight, and which features improved NVH performance, when compared to known rear suspension subframe designs.

The typical rear subframe assembly when adapted to accept a mechanical drive such as a differential, may limit packaging considerations. The traditional subframe assembly also typically requires a dual isolation system to reduce noise, vibration, and harshness from driveline and suspension loads. In the dual isolation system, the differential is isolated from a crossmember that spans between the vehicle frame rails and the crossmember is further isolated from the vehicle frame rails.

### BRIEF SUMMARY OF THE INVENTION

In accordance with the invention, a support assembly for an independent rear suspension of a motor vehicle includes a central member having a first end and a second end, and a pair of end members, each end member being secured to a respective end of the central member such that the central member structurally “bridges” the two end members. A portion of each end member extends away from the central member to define a land adapted to engage a respective one of the vehicle's generally-longitudinally-extending frame rails proximate to a nominal rear wheel location of the vehicle. The support assembly further defines at least a pair of attachment points, each attachment point of being adapted to pivotally support a lateral link of connecting the support assembly to a respective one of the vehicle's rear wheelend assemblies to be supported by the support assembly relative to the vehicle.

While the invention contemplates a variety of configurations for the central member by which to provide a structural bridge between the end members, in an exemplary embodiment, the central member includes a tubular section formed, for example, of a rolled steel sheet or extruded aluminum alloy. By way of further example, in the exemplary embodiment, the tubular section of the central member has a generally elliptical cross-section to provide enhanced structural rigidity, with an attendant reduction in relative height and weight. When the supporting assembly of the invention is secured as by bolts to the frame rails, the tubular section of the central member preferably extends in a direction generally normal to the frame rails so as to readily receive a shaft through an end of the central member that is suitably coupled to a rear wheelend assembly of the vehicle.

Similarly, while the invention contemplates a variety of end configurations for each end member, by which each end of the central member is to be mounted onto a respective frame rail, in an exemplary embodiment, each end member is generally U-shaped, with a bight portion secured to a respective end of the central member. Each U-shaped end member of the exemplary embodiment further includes a pair of arms extending from the bight portion, with each arm including a land adapted to engage a respective generally-longitudinally-extending frame rail proximate to a nominal rear wheel location of the vehicle. One arm of each end member includes an attachment point defined on the arm between the rail-engaging land and the bight portion of the respective end member, the attachment point being adapted to pivotally support a lateral link connecting the arm to a respective rear wheelend assembly of the vehicle.

In accordance with another aspect of the invention, the central member of the support assembly defines at least a portion of a housing adapted to receive an electric motor that is supported, relative to the frame rails of the vehicle, solely by the central and end members of the support assembly. A shaft projecting from each end of the resulting housing is coupled, as through constant velocity joints of known configuration, to a hub of a respective one of the wheelend assemblies, such that the electric motor housed within the central member is operable to drive the wheelend assemblies. Isolation mounts disposed between the lands of the arms and the frame rails advantageously isolate both the rear suspension and the vehicle driveline to thereby enhance vehicle NVH performance.

In accordance with yet another aspect of the invention, the central member may advantageously house other types of driveline components, for example, an eddy-current retarder, that are adapted to be coupled as through constant velocity joints to either or both of the vehicle's rear wheelend assemblies while being supported, relative to the vehicle's frame rails, solely by the central and end members of the support assembly. Additional examples of driveline components which may be housed within the central member and supported, relative to the vehicle's frame rails, solely by the central and end members include mechanical geared axle components, such as a hypoid gear set and differential, and hydrostatic drive components.

In accordance with yet another aspect of the invention, the support assembly advantageously provides modular flexibility with respect to the selection of the central and end members, depending upon the static and dynamic loads to be applied to the support assembly when mounted on a given vehicle, the packaging constraints presented by the vehicle, and the driveline component(s), if any, selected to be housed within the support assembly's central member. In this manner, it will be appreciated that the invention greatly facilitates the manufacturability of vehicle lines featuring a variety of driveline and powertrain configurations, including those variants utilizing nondriven rear wheelend assemblies in which a central member of reduced dimension may advantageously employed.

In accordance with yet another aspect of the invention, the support assembly advantageously provides modular flexibility with respect to the location of attachment points for the lateral links coupling the supported wheelend assemblies to the support assembly. By way of example, by placing one or more attachment points for the collateral links on the end members of the support assembly, driveline components housed within central members of “standardized” dimension are readily adapted to vehicles utilizing different suspension geometries. Further, because the central member may be designed to bridge a substantial separating distance between the end members greater than that necessary to physically accommodate the housed driveline components, the invention advantageously accommodates an asymmetrical positioning of any driveline components housed within the central member so as to provide yet additional packaging flexibility vis-à-vis other adjacent vehicle components, for example, a fuel tank.

In a second embodiment, the independent suspension includes a suspension system and a support assembly. The support assembly generally includes a central member and a first and second end member coupled to each of the side of the central member. The end members are also coupled to the suspension system so that the end members may receive suspension load from the suspension system and transfer that load to the other end member through the central member.

In an additional embodiment, the independent suspension includes a central member having a first and second end to which first and second end members are respectively coupled, and an input passage. The axle assembly includes an input member disposed in the input passage, a pair of output shafts extending from the ends of the central member, and a torque transfer device for transferring torque from the input member to the output shafts. The torque transferring device is enclosed within a cavity defined by the central member while the output shafts are rotationally coupled to wheel end assemblies of the vehicle. Further, the first and second end members are coupled to the vehicle chassis and wheel ends with the central member forming a structural bridge between the end members.

In yet another embodiment, the support assembly includes a central member, a first end member, and a second end member. The central member defines a cavity for housing a torque transfer device and forms a structural bridge between the end members. Each of the end members are coupled to a suspension system so that the central member is subjected to suspension load from the suspension system attached to the end members as well as driveline load.

Additional features, benefits, and advantages of the invention will become apparent to those skilled in the art to which the invention relates from the subsequent description of an exemplary embodiment and the appended claims, taken in conjunction with the accompanying Drawings.

### BRIEF DESCRIPTION OF THE DRAWINGS

In the Drawings, wherein like reference numerals are used to designate like components in each of the several views:

FIG. 1 is a view in perspective of an exemplary support assembly for an independent rear suspension of a motor vehicle having generally-longitudinally-extending frame rails, wherein the support assembly's central member houses an electric drive;

FIG. 2 is a top view of the exemplary support assembly of FIG. 1, partially broken away to show the electric motor housed within the support assembly's central member;

FIG. 3 is a bottom view of the exemplary support assembly, further illustrating the attachment points adapted to pivotally support lateral links connected to each wheelend assembly;

FIG. 4 is another view in perspective of the exemplary support assembly;

FIG. 5 is a perspective view of a second embodiment of the support assembly, partially cut away to show the torque transfer device;

FIG. 6 is a perspective view of the second embodiment of the independent suspension attached to a vehicle;

FIG. 7 is a front view of the second embodiment of the independent suspension attached to a vehicle; and

FIG. 8 is a perspective view of a third embodiment of the support assembly.

### DETAILED DESCRIPTION OF THE INVENTION

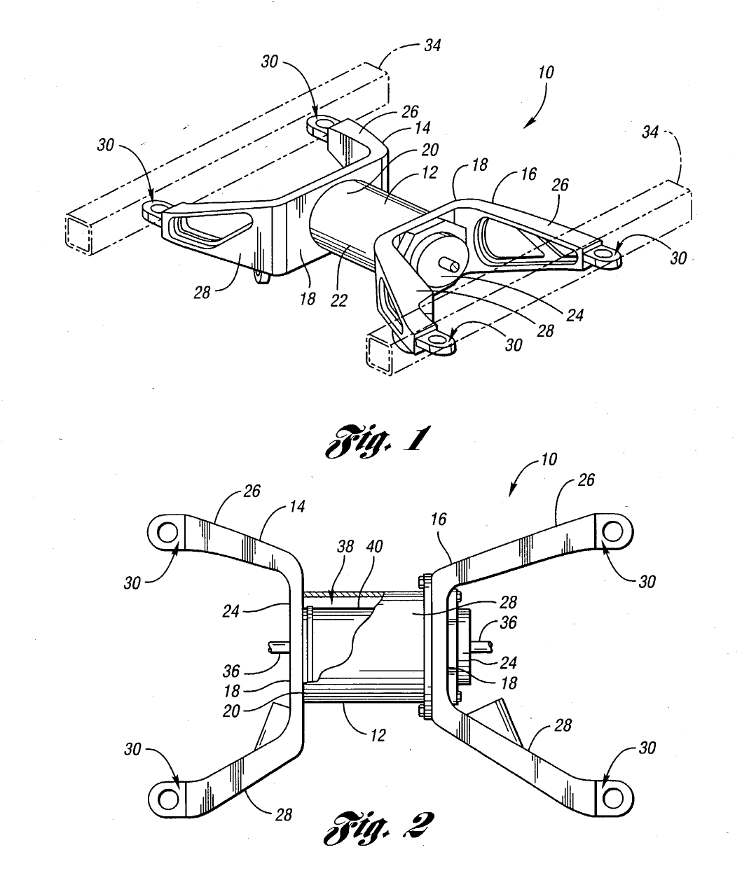

Referring to FIG. 1, an exemplary support assembly 10 for an independent rear suspension of a motor vehicle (not shown) includes an elongate, generally-tubular central member 12 that is conveniently formed of a rolled steel or aluminum alloy sheet stock. While the invention contemplates any suitable cross-sectional configuration for the central member 12 by which to provide the central member 12 with a desired structural rigidity, in the exemplary support assembly 10, the central member 12 has a generally elliptical cross-section that provides a desired strength and rigidity to the central portion of the support assembly 10 while further reducing the relative weight and height of the support assembly 10.

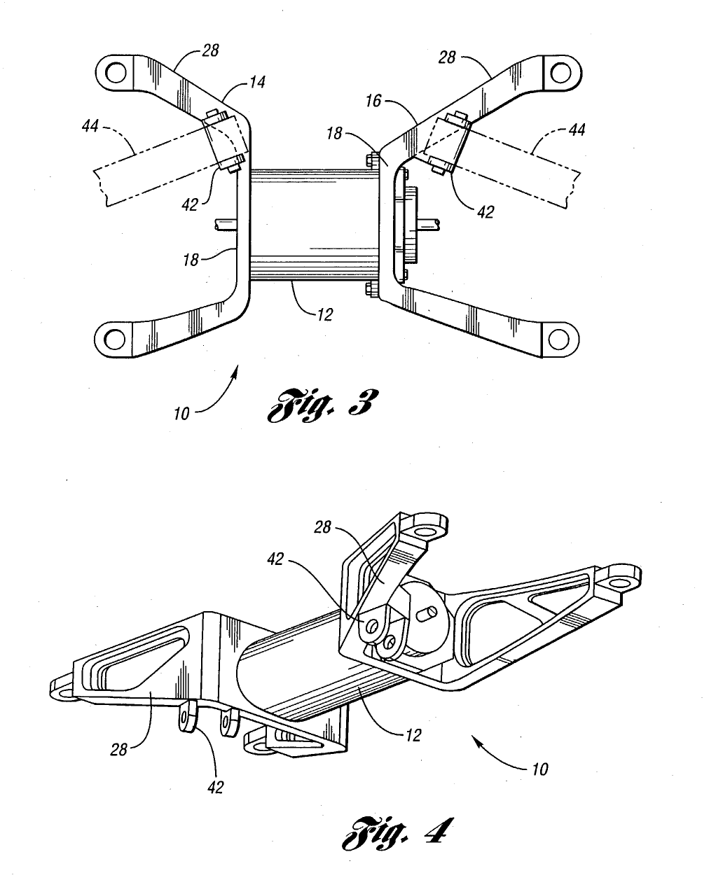

As best seen in FIGS. 1 and 2, a pair of generally U-shaped end members 14, 16 formed, for example, of a machined aluminum casting, each include a bight portion 18 that is secured to a respective end 20, 22 of the central member 12, for example, either permanently as by welding (as in the case of the first U-shaped member 14) or removably as by threaded fasteners (as in the case of the second U-shaped member 16). In this manner, the bight portions 18 of the U-shaped end members 14, 16 conveniently define at least a portion of an end cap 24 closing the respective ends 20, 22 of the central member 12.

Also referring to FIGS. 1 and 2, each U-shaped end member 14, 16 includes a pair of arms 26, 28 which extend from the bight portion 18 in a direction generally away from the central member 12. Each arm 26,28 includes a land 30, preferably located on the distal end of the arm 26,28, adapted to engage a respective generally-longitudinally-extending frame rail 34 of the vehicle, as illustrated in FIG. 1. When the supporting assembly 10 is secured as by bolts (not shown) to the frame rails 34 of the vehicle, the central member 12 extends in a direction generally normal to the frame rails 34 so as to readily accommodate a shaft 36 extending through each end cap 24 on the central member 12.

More specifically, as best seen in FIG. 2, the central member 12 of the support assembly 10 defines a housing 38 adapted to receive and support an electric motor 40, the respective output shafts 36 of which extend through the respective end caps 24 on the central member 12 to drive each of the vehicle's rear wheelend assemblies through suitable constant velocity joint connections (not shown).

As best seen in FIGS. 3 and 4, one arm 28 of each U-shaped end member 14,16 further includes an attachment point 42 located on the arm 28 between the arm's rail-engaging land and the end member's bight portion 18. The attachment point 42 on the arm 28 is adapted to support a lateral link 44 connecting the arm 28 to a respective rear wheelend assembly.

Referring again to FIG. 1, in accordance with an aspect of the invention, the electric motor 40 housed within the central member 12 of the support assembly 10 is supported relative to the frame rails 34 of the vehicle solely by the central member 12 and U-shaped end members 14,16 of the support assembly 10. It will be appreciated that a suitable isolation mount (not shown) disposed between the frame rails 34 and the corresponding rail-engaging land 30 of each arm 26,28 of the U-shaped end members 14,16 advantageously serves to isolate both the lateral link of the rear suspension and the electric drive, thereby enhancing vehicle NVH levels.

While the above description constitutes the preferred embodiment, it will be appreciated that the invention is susceptible to modification, variation and change without departing from the proper scope and fair meaning of the subjoined claims. For example, while an the electric motor housed within the central member is illustrated in FIG. 2 as a self-sufficient electric motor with an integrated case, it will be appreciated that the housing defined by the central member and the bight portions of the end members can itself form the external case of the motor, providing suitable locations for the motor armature, brushes and shaft bearings. The invention further contemplates locating an electrical interface between the electric motor and the vehicle's electrical system within the housing defined by the central and end members of the support assembly.

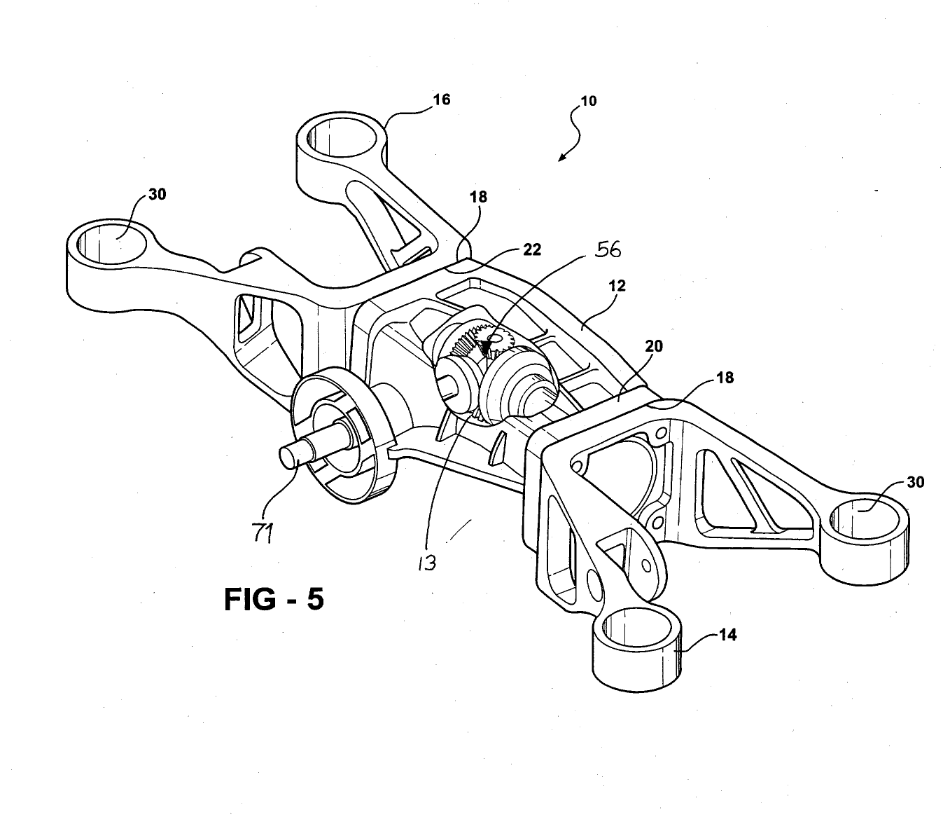

A second embodiment of the independent rear suspension 8 of the present invention will now be described with reference to FIGS. 5-7. In this embodiment, the support assembly 10 is configured to house and support an axle assembly 50 that receives a torque input from a drive shaft 52 and transfers the torque to wheel end assemblies 80 in a conventional manner. A suspension system 60 pivotally couples the wheel end assemblies 80 to the support assembly 10. The support assembly 10 again includes a central member 12 disposed between a pair of end members 14, 16. This configuration allows the support assembly 10 to span laterally across the vehicle with a central member 12 forming a structural bridge between the end members 14, 16. Therefore, while the support assembly 10 in the first embodiment accommodates suspension loads and any vibrational loading from the operation of the electric motor, the support assembly of the second embodiment accommodates suspension loads as well as the driveline loads exerted by the drive shaft 52 and moving components of the axle assembly 50. Driveline loads generally have greater frequency and amplitude than the vibrational loading of the electric motor due to the meshed gears used to transfer torque.

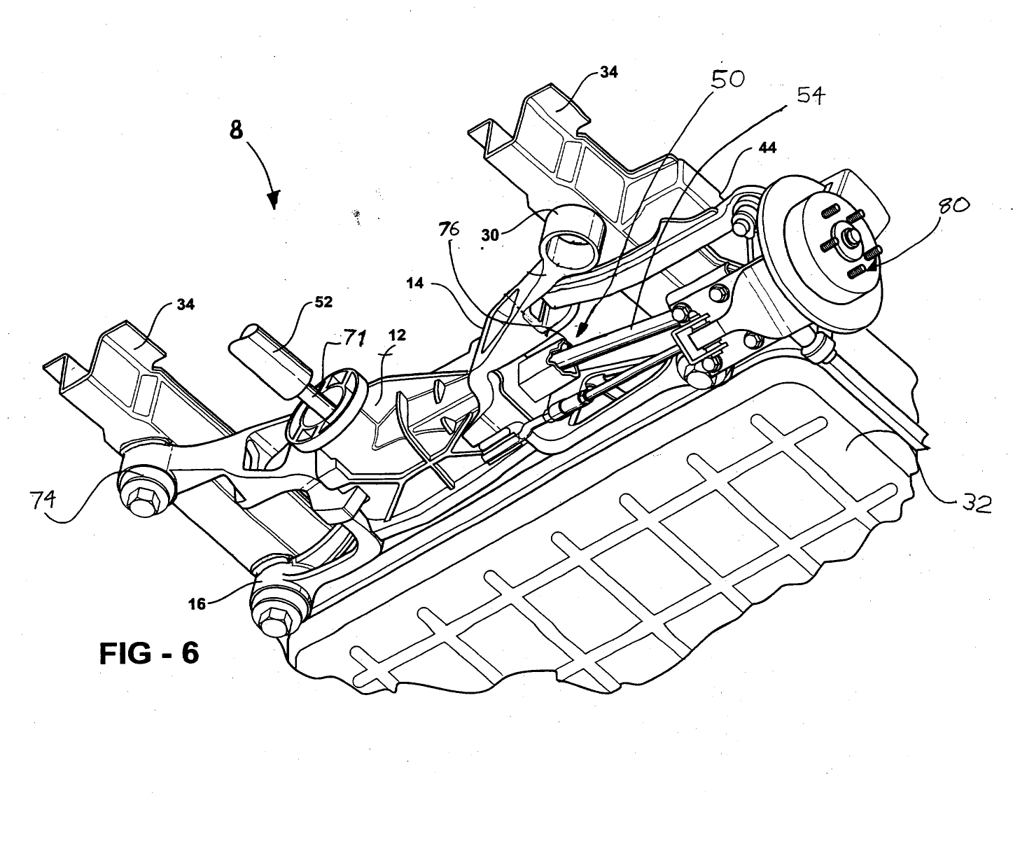

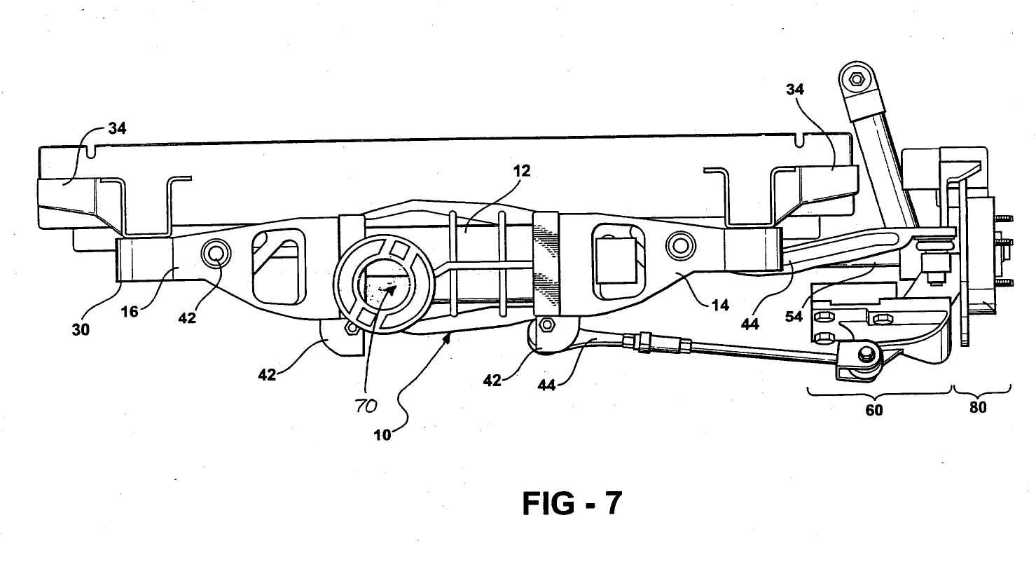

As described above and illustrated in FIGS. 6 and 7, the vehicle includes a vehicle chassis 32 having a pair of longitudinally extending frame rails 34. The support assembly 10 may be coupled to the frame rails 34 using a variety of configurations such as isolation mounts 74 described in greater detail below.

The support assembly 10 is again constructed in a modular arrangement to allow the central member 12 or end members 14, 16 to be used across different vehicle platforms. More specifically, the modular arrangement may allow the central member 12 or end members 14, 16 to be constructed in a uniform manner. For example, a single configuration of the central member 12 may be used with various sizes, shapes, and styles of end members 14, 16 in order to tailor the support assembly 10 to specific vehicle platforms thereby achieving reductions in manufacturing cost and assembly time. Further, by using a uniform central member 12, a uniform device for transferring input torque from the drive shaft 52 to the wheel end assemblies 80 may be also used, further reducing the manufacturing costs.

The central member 12 may be formed in a variety of shapes, sizes, and styles to house various torque transfer devices and for use in different vehicle platforms. The central member 12 is generally configured to receive and support the axle assembly 50. The axle assembly 50 is formed as is well known in the art and generally includes an input member 72 coupled to a torque transfer device 56 which in turn is connected to the wheel end assemblies 80 with a pair of output shafts 54. The central member 12 includes a cavity 13, an input passage 70, and output passages 76. The torque transfer device 56, such as a differential, is housed within the cavity 13. In the illustrated embodiment, the torque transfer device 56 is a differential and the central member 12 is configured to act as a differential case. The central member 12 receives the driveline load from the torque transfer device, such as vibrations from gear mesh, vibrations from rotating gears, and the load in keeping the gears meshed. The input member 72 is retained within the input passage 70 allowing it to communicate between the driveshaft 52 and the torque transfer device 56. Driveline load is also applied from the driveshaft 52 and input member 72 to the central member 12 generally through the input passage 70. The output shafts 54 are coupled to the torque transfer device 56 and extend outward through the output passages 76 to the wheel end assemblies 80. Driveline load may also be applied by the output shafts 54 through the output passages 76. Therefore, the central member 12 is configured to carry both driveline load and suspension load.

As shown in FIGS. 6 and 7, isolation mounts 74 may be disposed between the land 30 and the frame rails 34 to isolate suspension loads and driveline loads from the vehicle chassis 32. These isolation mounts 74 are preferably tuned to reduce both driveline load, having low amplitude high frequency vibrations, and suspension load, having high amplitude low frequency vibrations. Notwithstanding this preferred configuration, conventional isolation mounts, such as those tuned to reduce suspension loading alone may be suitable for use with the invention. The configuration of the support assembly 10 also provides reduction in driveline loading. More specifically, the central member 12 being formed to withstand suspension loading, not typically carried by a traditional transfer case or differential case, and being constrained between the end members 14, 16 reduces driveline vibrations to an acceptable level so that only single isolation system using isolation mounts tuned for suspension loading is needed.

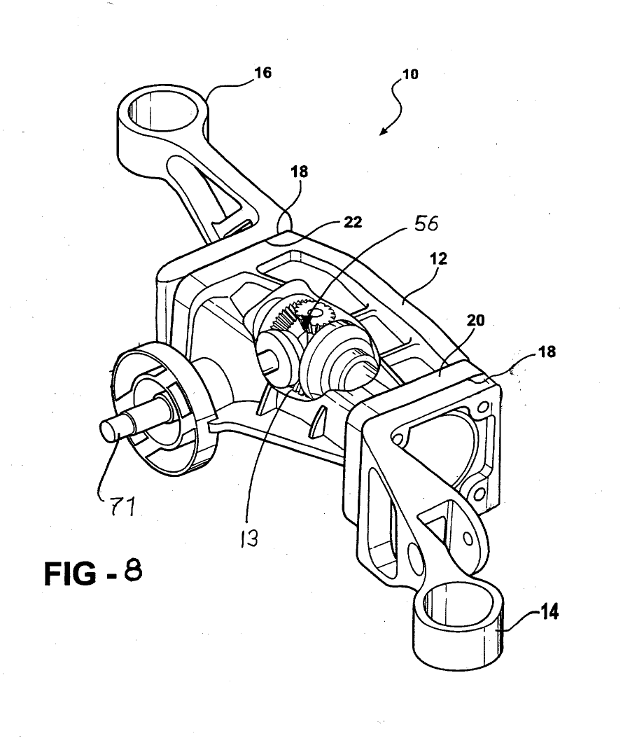

As described above, the end members 14, 16 may be coupled to the central member 12. The end members 14, 16 are generally connected to the end wheel assembly 80 through the suspension system 60. Attachment points 42 may be located on the end members connecting them to the wheel end assembly with lateral links, tie rods or any other device well known in the art that allow the wheel end assembly 80 to be pivotally coupled to the structural member 10. The end members 14, 16 may be made in any size and shape and an exemplary alternative embodiment is shown in FIG. 8.

With the central member 12 being disposed between the two end members 14, 16 and acting as a structural bridge, the central member receives not only driveline but also suspension load. For example, suspension load applied to one end member 14, 16 may be passed through the central member 12 to the opposing end member 14, 16. Also driveline load applied to the central member 12 may be transferred to the end members 14, 16. The configuration of the support assembly 10 having the central member 12 disposed between the end members with the load portions 30 that connect the support assembly 10 to the vehicle rails 34 being spread over a large area allows the loading to be spread out thereby reducing noise, vibration, and harshness issues. The configuration of the support assembly 10 allows greater variations in packaging and generally more ground clearance than a traditional subframe to which a torque transfer device is bolted to the underside.

As illustrated in FIG. 5, the central member 12 includes ribbing to strengthen the central member. Due to the configuration of the structural assembly 10, even though the central member 12 has more material than a traditional differential case, the overall structural assembly 10 generally weighs less than a traditional assembly having a subframe spanning the vehicle to which a traditional differential case is attached, because the traditional subframe is eliminated.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. An independent suspension of a vehicle, wherein the vehicle includes a chassis having rails and a driveshaft providing torque, said independent suspension comprising:
a suspension system; and
a support assembly including:
a central member having a first end and a second end, and
a first and second end member, wherein one of said end members is coupled to said first end and the other to said second end, each of said end members being operatively coupled to a suspension system and wherein each of said end members receives and transfers load from said suspension system through said central member to the other of said end members.

2. The independent suspension of claim 1 further including a torque transferring device and wherein said central member defines a cavity configured to receive the torque transferring device.

3. The independent suspension of claim 2 wherein said torque transferring device is a differential and said central member is a differential case.

4. The independent suspension of claim 2 wherein the driveshaft is operably coupled to said torque transferring device, the driveshaft and said torque transferring device applying a driveline load to said central member.

5. The independent suspension of claim 4 wherein said central member transfers a portion of said driveline load to said end members.

6. The independent suspension of claim 1 wherein each of said end members is secured to the rails.

7. The independent suspension of claim 6 wherein each of said end members includes at least one land adapted to engage said rails, and wherein each of said lands includes an isolation mount.

8. The independent suspension of claim 1 further including a wheel end assembly, said suspension system connecting said wheel end assembly to the vehicle and to said support assembly.

9. The independent suspension of claim 8 further including an output shaft coupled to said wheel end assembly and extending into said central member.

10. An independent suspension of a vehicle, wherein the vehicle includes a chassis having rails extending generally longitudinally along the vehicle and a driveshaft providing torque, said independent suspension comprising:
a central member defining a cavity, said central member including a first end, a second end and an input passage;
an axle assembly including an input member disposed in said input passage and coupled to said driveshaft, a pair of output shafts, and a torque transferring device, said torque transferring device transferring torque from said input member to said output shafts, said torque transferring device being enclosed within said cavity and said output shafts being rotationally coupled to a wheel end assembly; and
a first and second end member, each of said end members being secured to a respective end of said central member and, coupled to said chassis and said wheel end assembly, said central member forming a structural bridge between said end members.

11. The independent suspension of claim 10 further including a suspension system operationally coupling said wheel end assembly to said structural member.

12. The independent suspension of claim 11 wherein said suspension system further includes a lateral link pivotally coupling said wheel end assembly and said structural member and wherein at least one of said central member and said end members define a pair of attachment points adapted to pivotally support said lateral link.

13. The independent suspension of claim 12 wherein said suspension system applies a suspension load to end members, and wherein said end members apply suspension load to said central member.

14. The independent suspension of claim 13 wherein the driveshaft and said torque transfer device apply driveline load to said central member.

15. A support assembly for an independent rear suspension of a vehicle wherein the vehicle includes a chassis having rails extending generally longitudinally along the vehicle, a suspension system and a driveshaft, said structural member comprising:
a central member having a first end and a second end and said central member defining a cavity housing a torque transfer device, said torque transfer device operatively coupled to the driveshaft; and
a first and second end member each being secured to a respective end of the central member such that the central member forms a structural bridge between the end members, each of said end members being operatively coupled to said suspension system and wherein said central member is subjected to driveline load from the driveshaft and said torque transferring device as well as suspension load from the suspension system attached to said end members.

16. The support assembly of claim 15 wherein each of said end members defines at least one land adopted to engage the respective rail.

17. The support assembly of claim 16 wherein the central member and one of the end members defines a pair of attachment points, each attachment point operatively coupled to the suspension system.
